(19) United States
(12) Patent Application Publication
(10) Pub. No.: US 2005/0214427 A1
(43) Pub. Date: Sep. 29, 2005

(54) Cold-mixed pie crust having reduced saturated fats and zero hydrogenated fat constituents

(76) Inventors: Wendy Zellen, Maple (CA); Van Miller, Erin (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/806,410

(22) Filed: Mar. 23, 2004

(51) Int. Cl. A21D 10/00

(52) U.S. Cl. 426/549

(57) ABSTRACT

A cold-mixed pie crust comprises flour, water, and a frozen oil/fat system as its major constituents. The frozen oil/fat system is a frozen long-chain, naturally occurring oil having at least sixteen carbon atoms; and is chosen from the group consisting of canola oil, flaxseed oil, sunflower oil, corn oil, olive oil, soybean oil, peanut oil, cottonseed oil, safflower oil, and palm oil, and mixtures and combinations thereof. A method of making the cold-mixed pie crust mixture comprises the steps of (a) cooling a naturally occurring long-chain oil having at least sixteen carbon atoms to a freezing temperature in the range of +5° C. to −35° C., so as to obtain a frozen oil/fat system; (b) cooling water to a temperature in the range of 0° C. to +15° C.; and (c) mixing flour, cooled water, and the frozen oil/fat system to form a cold-mixed pie crust mixture.

### FIELD OF THE INVENTION

This invention relates to pie crust pastry, and particularly to pie crusts that are made from the pastry. The invention is specifically directed to pie crusts that are mixed cold, and which comprise a frozen oil/fat system as their shortening constituent.

### BACKGROUND OF THE INVENTION

For many years, commercial bakeries have provided pies to the market. Such pies include traditional fruit pies and the like that are typically eaten for dessert, as well as meat pies, chicken pies, and the like. Many small pies and tarts are also included in the pie inventory provided by commercial bakeries. The pie crusts for all such products are prepared from a pie crust pastry which has, as its principal constituents, flour, water, salt, and a fat system. Traditionally, the fat system has been lard; however, for many persons who have been conscious of fat intake from lard, either because of a perceived cholesterol problem or because they do not wish to consume animal fat or fat derived from pork, vegetable shortening has been employed as the fat system.

Indeed, other factors including shortness of supply and particularly economics of supply, have resulted in wide scale use of vegetable shortening in the commercial baking industry for the production of pie crusts. Such vegetable shortenings typically are derived from hydrogenated oils, which oils may typically be palm oil, soybean oil, cottonseed oil, canola oil, and mixtures thereof, most of which are at least partially if not profoundly hydrogenated.

The choice of the fat system in a pie crust pastry formulation will have an effect on the nature and character of the pie crust which will be provided. Also, the manner in which the pastry formulation is handled will also have an effect on the nature and character of the pie crust. However, the present invention is concerned with the fat system to be used, it being understood that persons skilled in the art will be well-versed in the preparation of pie crusts and the manner of handling the pastry from which the pie crusts will be made.

Since the turn of the 21^{st} century, in particular, many consumers, and many commercial bakeries who provide products for those consumers, are becoming concerned with the problem of human obesity, as well as health problems surrounding the consumption of hydrogenated oils of all sorts. The consumption of trans fatty acids is also of concern. Indeed, many members of the baking industry, particularly bread and cookie and biscuit bakers, are making well-publicized attempts to eliminate or reduce the inclusion of hydrogenated fats as well as trans fatty acids in their baked commercial products. The apparent acceptance by many consumers of the so-called Atkins Diet has also led to a determined and much publicized attempt by the baking industry to reduce carbohydrate intake in general. Adherents of that plan, and other health conscious individuals, are concerned with controlling their caloric intake of fats, and opt particularly for fats and fat containing products that are free of hydrogenation and free of trans fats.

Referring especially to pastry crusts, many consumers prefer a flaky crust as opposed to a mealy crust. Once again, the handling of the pastry, as well as the conditions in which the pastry is handled, will affect the flakiness or mealiness of the crust. Traditionally, it has been considered that the best temperature for both the shortening and the flour is in the range of +12° C. to +15° C., and that the water which is added to the pastry mix should be cold—typically, in the range of +5° C. to +8° C.

However, typically the pastry formulation is prepared at room temperature of, say, +22° C. to +26° C. Moreover, when finished, and before the pie crusts are further prepared either by baking or having filling placed in them, the pie crusts are also effectively held at room temperature.

The pie crusts which are the subject of the present invention may leave the commercial bakery preparation room in one of a number of different forms. In some instances, they may be frozen and shipped to a retailer for sale to consumers as frozen pie crusts into which filling will be placed and the pie baked by an individual homemaker. More particularly, however, the pie crusts which are the subject of the present invention will go in a frozen state to a retailer with the filling already in place, or for the retailer to place the filling into the pie crust, after which the retailer will bake the pie for sale as a fresh-baked pie for immediate consumption by the customer. Of course, in some instances it may also be that the commercial bakery will bake pies which will then be shipped to retailers for sale as pre-baked pies, which may then be either warmed up or served cold. Until the present invention, however, all such pie crusts have either had lard or hydrogenated vegetable oil shortening, or both, as the fat system constituent thereof.

The present inventors have unexpectedly discovered that a fat system can be employed which reduces the saturated fat content of pie crust pastry formulations, and which totally eliminates or precludes the necessity to employ hydrogenated fats as part of the fat system or shortening employed in the preparation of pie crust pastry formulations and the pie crusts made from them.

To that end, the present inventors have quite unexpectedly discovered that a frozen oil/fat system can be employed where the frozen oil/fat system is a frozen long-chain, naturally occurring oil or combination of naturally occurring oils, all of which have at least 16 carbon atoms. Typically, as will be discussed in greater detail hereafter, such naturally occurring oils are C₁₈ and above, and may be saturated, partially saturated, or unsaturated. Moreover, while there may be minor presence of trans fatty acids, none of the oils employed in keeping with the present invention is hydrogenated.

Still further, the present inventors have quite unexpectedly discovered that extremely good results can be achieved with frozen oil/fat systems when the pie crust pastry is cold-mixed; that is, that the environment within which the pie crust pastry is prepared is typically at a temperature of between +5° C. and +20° C. The frozen oil/fat systems typically have a temperature of between +5° C. and −35° C. (usually in the range of 0° C. to −20° C.), and are typically such that they have a consistency which is similar to that of pork lard at +4° C.

To that end, the oils which are most advantageously employed in the production of pie crust pastry and pie crusts in keeping with the present invention are typically naturally occurring C₁₈ vegetable oils. Such oils are typically quite complex, in terms of their saturation level and in terms of the presence or absence of trans fatty acids, but they are predominantly C₁₈ oils. Some minor exceptions may occur, as noted hereafter. The characteristics of a number of those oils that are found to be particularly advantageous in carrying out the present invention are set out below. For the sake of comparison, the characteristics of lard are also noted.

TABLE 1

| | | | | Mono-unsaturated | | Poly-unsaturated | | | |
|---|---|---|---|---|---|---|---|---|---|
| Dietary Fat | Saturated Fat % | | | Fat % | | Fat % | | Other | |
| Canola Oil | C_{16:0} | 4 | 6 | C_{18:1} | 62 | C_{18:2} | 22 | | |
| | C_{18:0} | 2 | | | | C_{18:3} | 10 | | |
| Safflower Oil | C_{16:0} | 8 | 11 | C_{18:1} | 13 | C_{18:2} | 75 | C_{18:3} | 1 |
| | C_{18:0} | 3 | | | | | | C_{20:1} | |
| Sunflower Oil | C_{16:0} | 8 | 11 | C_{18:1} | 20 | C_{18:2} | 67.8 | | |
| | C_{18:0} | 3 | | | | | | | |
| Corn Oil | C_{16:0} | 12 | 14.2 | C_{18:1} | 27 | C_{18:2} | 57 | C_{18:3} | 1 |
| | C_{18:0} | 2.2 | | | | | | C_{20:1} | |
| Olive Oil | C_{16:0} | 14 | 16 | C_{18:1} | 64 | C_{18:2} | 16 | | |
| | C_{18:0} | 2 | | | | | | | |
| Soybean Oil | C_{16:0} | 11 | 15 | C_{18:1} | 25 | C_{18:2} | 50 | C_{18:3} | 8 |
| | C_{18:0} | 4 | | | | | | C_{20:1} | |
| Peanut Oil | C_{16:0} | 11 | 20.1 | C_{18:1} | 46 | C_{18:2} | 31 | C_{18:3} | 1.5 |
| | C_{18:0} | 3 | | | | | | | |
| | C_{22:0} | 3.3 | | C_{22:1} | 23.5 | | | C_{20:1} | |
| | C_{24:0} | 1.3 | | | | | | | |
| | C_{20:0} | 1.5 | | | | | | | |
| Cottonseed Oil | C_{16:0} | 23.5 | 26 | C_{18:1} | 18 | C_{18:2} | 54 | C_{18:3} | 0.3 |
| | C_{18:0} | 2.5 | | | | | | C_{20:1} | |
| Palm Oil | C_{16:0} | 46 | 50 | C_{18:1} | 37 | C_{18:2} | 10 | C_{18:3} | 0.3 |
| | C_{18:0} | 4 | | | | | | C_{20:1} | |
| Lard | C_{14:0} | 2 | 34 | C_{18:1} | 46 | C_{18:2} | 14 | C_{18:3} | 1 |
| | C_{16:0} | 23 | | | | | | C_{20:1} | |
| | C_{18:0} | 9 | | | | | | | |

Cholesterol Content for Lard: 12 mg/Tbsp. No cholesterol in any vegetable-based oils. Percentages may not add to 100% due to rounding and other constituents not listed.

It will be noted that the listed vegetable oils are predominantly C₁₈ and C₁₆.

The freezing points of the above oils and mixtures, and combinations thereof, will vary from about +5° C. to −35° C., typically 0° C. to −20° C. In any event, when the oil has been frozen it will have a consistency which is not dissimilar to that of hydrogenated vegetable oil shortening—especially when cold (below +5° C.)—or pork lard at about +4° C.

It will be well understood by those skilled in the art that flaky pastries will best be prepared when the consistency of the shortening is such that it will not smear into the flour too easily, and when the flour and shortening are no warmer than, and preferably cooler than, room temperature. As noted, however, the inventors herein have discovered that the best results when frozen oil/fat systems in keeping with present invention are employed occur when the mixing environment—the room where the mixing occurs or at least a jacketed mixer whose interior temperature can be controlled—is no warmer than +20° C. and preferably closer to +5° C.

It has also been discovered by the present inventors that the flakiness of pie crust pastries in keeping with present invention may also be effected by the profundity of the frozen state of the frozen oil/fat system. For example, if the frozen oil/fat system has been totally frozen to the state where it is no longer a eutectic mixture, then a flakier crust will be achieved. If, the other hand, the frozen oil/fat system is such that it has apparent solidity but yet remains a eutectic mixture of solid and liquid crystal structures, then a more mealy pie crust will be achieved. Of course, it will be well understood by those skilled in the art that the amount and manner of working the pastry formulation will be dependent at least to some extent on the hardness of the frozen oil/fat system being employed.

It will also be apparent to those skilled in the art that a more solid oil or fat system is easier to handle then one which is liquid, even if it may be highly viscous oil. Moreover, more solid fat systems, especially frozen oil/fat systems in keeping with the present invention, are such that the oil of the fat system is less likely to be absorbed by the flour of the pastry formulation.

Many commercial cooking operations, particularly commercial bakeries and the like, that employ liquid vegetable oils will ‘winterize’ the oils—meaning that the oils are treated so that they do not to go cloudy by the initial crystallization of solid fat crystals at low temperatures in the range of 0° C. up to about +5° C. That means that the oils can be refrigerated without going cloudy. However, winterization of naturally occurring C₁₈ and higher vegetable oils that are intended to be employed in keeping with present invention is unnecessary, and may result in difficulty in expeditious practice of the present invention.

It is well known that the use of cold water in the preparation of pie crust pastry is advisable. Unexpectedly, the present inventors have discovered that up to 50% of the water content of the pie crust pastry formulation can be ice, in the form of shaved ice, flaked ice, or finely ground ice. Further discussion of this and other conditions surrounding the mixing environment in which they pie crust pastries in keeping with present invention are prepared will follow, hereafter.

The present invention also provides methods for the preparation of cold-mixed pie crust mixtures. Several representative formulations are discussed hereafter.

### SUMMARY

To that end, the present invention provides a cold-mixed pie crust which comprises as its major constituents flour, water, and a frozen oil/fat system.

The frozen oil/fat system is a frozen long-chain, naturally occurring oil having at least sixteen carbon atoms.

Typically, the oil of the frozen oil/fat system is a naturally occurring saturated, partially saturated, or unsaturated oil chosen from the group consisting of canola oil, flaxseed oil, sunflower oil, corn oil, olive oil, soybean oil, peanut oil, cottonseed oil, safflower oil, palm oil, and mixtures and combinations thereof.

The oil which is chosen has a freezing point of between +5° C. and −35° C., at which it has a consistency which is similar to that of pork lard at +4° C.

In general, the major constituents of the cold-mixed pie crust pastry of the present invention are mixed together in a room or mixing environment having a temperature in the range of +5° C. to +20° C.

Up to 50% of the water constituent of the cold-mixed pie crust, when first mixed at least with the flour constituent, may be shaved, flaked, or finely ground ice.

Typically, the ranges of the major constituents, in weight percentage, are as follows:
flour 45% to 59%
water 9% to 18%
frozen oil/fat system 22% to 35%

Moreover, the cold-mixed pie crust of the present invention may further comprise minor constituents that are chosen from the group consisting of:
zero to 6.00% by weight of sweeteners;
zero to 2.00% by weight of salt;
zero to 0.50% by weight of leavening;
zero to 0.75% by weight of preservative.

Typically, the temperature of the flour constituent prior to mixing the cold-mixed pie crust of the present invention is in the range of 0° C. to +15° C.

Also, when first mixed, the temperature of the pie crust mixture is typically in the range of +5° C. to +10° C.

In general, the oil which is employed in the cold-mixed pie crust mixture in keeping with present invention is non-winterized.

The present invention also provides a method for producing a cold-mixed pie crust mixture which has reduced saturated fat and zero hydrogenated fat constituents. The method comprises the steps of:
(a) cooling a naturally occurring long-chain oil having at least sixteen carbon atoms to a freezing temperature in the range of +5° C. to −35° C., so as to obtain a frozen oil/fat system;
(b) cooling water to a temperature in the range of 0° C. to +15° C.; and
(c) mixing flour, cooled water, and the frozen oil/fat system of step (1), to form a cold-mixed pie crust mixture.

In general, the flour is cooled to temperature of 0° C. to +15° C. prior to step (c).

Typically, step (c) is carried out in a room or mixing environment which has a temperature of +5° C. to +20° C.

The method of the present invention also provides that the oil of the frozen oil/fat system is a naturally occurring saturated, partially saturated, or unsaturated oil chosen from the group consisting of canola oil, flaxseed oil, sunflower oil, corn oil, olive oil, soybean oil, peanut oil, cottonseed oil, safflower oil, palm oil, and mixtures and combinations thereof.

Moreover, typically the frozen oil/fat system from step (a) has a consistency similar to that of pork lard at +4° C.

The method of the present invention allows that the cooled water of step (b) may be substituted by cold water together with up to 50% by weight of the water constituent of shaved, flaked, or finely ground ice.

As before, the ranges of the flour, water, and frozen oil/fat system constituents of the pie crust mixture are as follows:
flour 45% to 59%
water 9% to 18%
frozen oil/fat system 22% to 35%

Moreover, the ranges of minor constituents which may also be present in the pie crust mixture as it is prepared in keeping with the method of the present invention may be chosen from the group consisting of:
zero to 6.00% by weight of sweeteners;
zero to 2.00% by weight of salt;
zero to 0.50% by weight of leavening;
zero to 0.75% by weight of preservative.

A particular provision of the method of the present invention is that the temperature of the mixture of step (c) is in the range of from +5° C. to +10° C.

As before, a particular provision of the method of the present invention is that the oil which is employed is non-winterized.

### DESCRIPTION OF THE PREFERRED EMBODIMENTS

It has been noted that the principal objectives of the present invention are to provide a cold-mixed pie crust which employs a frozen oil/fat system as one of its major constituents, in the place of shortening or lard; and also to provide a method for producing such a cold-mixed pie crust. It has been noted that many of the naturally occurring, long-chain oils that may be employed in keeping with the present invention are predominantly C₁₈; and that any of the oils which are employed have at least sixteen carbon atoms in any event.

Thus, the frozen oil/fat system which is employed in the place of shortening or lard in the production of the pie crust pastry is a frozen, typically predominantly C₁₈, oil which is otherwise untreated—at least insofar as such chemical treatments as hydrogenation may be concerned—but which otherwise may be filtered and mixed in various combinations as may be deemed appropriate. The freezing point for such naturally occurring long-chain vegetable oils may be as high as +5° C. or as low as −35° C., but typically such freezing points are in the range of 0° C. to −20° C.

However, it is also noted that naturally occurring long-chain vegetable oils may be more frozen or less frozen, depending in part on the length of time that they have been exposed to cold temperatures, and depending in part on the specific oils and mixtures thereof that are being frozen. Thus, a less hard or more hard frozen oil/fat system may be produced in keeping with provisions of the present invention, and such frozen oil/fat systems may be defined in terms of their hardness, their SFI (solid fat index) characteristics, eutectic curve placement, and so on.

The naturally occurring long-chain vegetable oils may be batch frozen or continuously frozen, depending on the quantities required and the facilities available.

Batch freezing requires placing the oils in suitable containers such as vats, tubs, or pails, and placing the containers into a freezer for a period of time ranging from a few to many hours. As noted, the hardness of the frozen oil/fat system which is thus derived will be a factor of the specific oil or oil mixture, the dwell time in the freezer, and the temperature of the freezer. If the long-chain oils are to be continuously frozen, then they will be fed to a swept surface heat exchanger in a matter well known to those skilled in the art.

As noted, the naturally occurring long-chain vegetable oils which are employed in keeping with the present invention may be saturated, but typically they are partially saturated, or they may be unsaturated. The oils may contain a small quantity of trans fatty acids; and if so, the presence of such an oil as palm oil will result in faster freezing of the oil mixture. Typical oils include canola oil and soybean oil, but any of the following oils, and mixtures and combinations thereof, may be employed in keeping with the present invention: canola oil, flaxseed oil, sunflower oil, corn oil, olive oil, soybean oil, peanut oil, cottonseed oil, safflower oil, and palm oil.

Examples of several typical frozen oil/fat systems, and their hardness as determined by penetrometer, with similar results for lard, are noted below. The penetrometer tests were carried out at different temperatures as noted, and measure the amount of penetration of a test probe into the surface of the frozen oil or lard per 10 seconds. Such tests are well known to those skilled in fat chemistry, and who study the physical characteristics of fats and oils.

TABLE 2
Micropenetrations at mm/10 seconds at
different temperatures of long chain oils and lard as a comparison

| | | Soya Oil/ | | |
|---|---|---|---|---|
| Temperature ° C. | Canola Oil | Flaxseed Oil | Sunflower Oil | Lard |
| 10 | N/A | N/A | N/A | 41 |
| 5 | N/A | N/A | N/A | 25 |
| 0 | N/A | N/A | N/A | 5 |
| −5 | 21 | 17 | 13 | 0 |
| −10 | 12 | 10 | 11 | 0 |
| −15 | 5 | 3 | 4 | 0 |
| −20 | 0 | 0 | 0 | 0 |

Samples were chilled for sixteen hours to 0° C., and two hours thereafter for each reduction of 5° C. Length of crystallization time may vary penetration value.

It will be noted that penetration values of the vegetable are not recorded at temperatures above 0° C., as those samples had not yet frozen to a hardened state. It will also be noted that the penetration values of the vegetable oils at −5° C. are not dissimilar to the penetration values of lard at +5° C.; and that the lard was too hard for penetration values to be recorded at temperatures at and below −5° C.

In keeping with the present invention, cold-mixed pie crust pastries will comprise as their major constituents flour, water and a frozen oil/fat system as provided by the present invention. Salt is usually included in nearly every pie crust formulation; and if so, it is present in minor quantities. Indeed, other minor constituents are very often used in various pie crust formulations, including sweeteners such as glucose, dextrose, and sugar. If so, they may appear in the pie crust formulation in an amount up to 6.00%. Leavening may appear in the pie crust formulation in an amount up to 0.50%; and a preservative such as sodium propionate may also be employed in an amount up to 0.75%. All such percentages of minor constituents expressed above will be understood to be weight percentages of the pie crust formulation being produced.

In order for the pie crust formulation to be cold-mixed, in keeping with the present invention, it is mixed in a mixing environment such as a room or a jacketed mixer whose interior temperature can be controlled, where the temperature of the mixing environment is typically in the range of +5° C. up to 20° C.—usually at the lower end of that range.

Moreover, so as to enhance the fact that the pie crust formulation in keeping with the present invention not only has a frozen oil/fat system as a starting material, it has been discovered that up to 50% of the water constituent of the pie crust formulation may first enter the mixing process as ice in the form of shaved ice, flaked ice, or finely ground ice. Among other things, this ensures that there is less likelihood of oil absorption by the flour constituent of the pie crust formulation.

The ranges of the major constituents of pie crust formulations in keeping with the present invention may be as follows:
flour 45% to 59%
water 9% to 18%
frozen oil/fat system 22% to 35%

Several examples follow of several typical pie crust formulations which were prepared in keeping with the present invention but in relatively small batches, in terms of commercial bakery operations, of only several hundred kilograms each. The examples which follow are expressed in weight percentages of the major and minor constituents which were employed in each of the formulations described below:

### EXAMPLE 1

flour 50.762%
water/ice 11.549%
frozen oil/fat system 34.264%
sweeteners 2.347% salt 1.015%
preservative 0.063%

### EXAMPLE 2

flour 50.913%
water/ice 12.092%
frozen oil/fat system 34.048%
sweeteners 1.973%
salt 0.891 %
preservative 0.083%

### EXAMPLE 3

flour 56.145%
water/ice 13.628%
frozen oil/fat system 28.072%
sweeteners 0.749%
salt 1.219%
preservative 0.187%

### EXAMPLE 4

flour 52.736%
water/ice 9.888%
frozen oil/fat system 32.960%
sweeteners 2.735%
salt 1.582%
preservative 0.099%

In each example, the temperature of the flour constituent prior to mixing was in the range of 0° C. up to +15° C.; the pastry formulations were mixed in a mixing environment of about +5° C. to +15° C.; and the temperature of the mixed pastry formulations, when the mixing stage was completed, was in the range of +5° C. to +10° C.

None of the oils which were employed had been winterized.

Each of the test batches prepared in keeping with the above weighed 234 kg. A 234 kg batch of ordinary commercial pie crust pastry using ordinary vegetable oil shortening having hydrogenated oils and trans fats as its principal ingredients was also prepared for comparison purposes. The comparison batch of pastry comprised 80 kg of fat content, and the test batches noted above comprised from about 66 kg to 82 kg of frozen oil/fat system.

However, the commercial pastry formulation included 19 kg of saturated fatty acids and 23.8 kg of trans fatty acids—a total of 42.8 kg of saturated and trans fatty acids, or over 50% of the total fat content. On the other hand, the frozen oil/fat systems in keeping with the present invention contributed zero trans fatty acids and an average of only 4.8 kg of saturated fatty acids—about 11% of the saturated and trans fatty acid contribution of ordinary commercial formulations.

All of the pie crusts produced from the examples above demonstrated acceptable flakiness, color, and flavor, when baked.

In keeping with the present invention, the following steps comprise the method of producing a cold-mixed pie crust mixture which has reduced saturated fat and zero hydrogenated fat constituents. The steps of the method are as follows:
(a) First, a naturally occurring long-chain oil having at least sixteen carbon atoms (C₁₆, C₁₈, etc.) is cooled to a temperature which is in the range of +5° C. to −35° C., and which in any event is the freezing temperature of the oil being cooled, or below that freezing temperature. By so doing, a frozen oil/fat system is obtained.
(b) Also, water is cooled to a temperature which is in the range of 0° C. to +15° C.
(c) Finally, flour is mixed with the cooled water and the frozen oil/fat system to form a cold-mixed pie crust mixture.

As noted previously, typically the flour is cooled prior to being mixed with the cooled water and a frozen oil/fat system, so the flour may be at a temperature of 0° C. up to +15° C.

As discussed previously, the mixing is carried out in a room or in a mixing environment such as a jacketed mixer, such that the temperature of the environment at which the mixing is carried out is in the range of +5° C. to +20° C.

Thus, the present invention provides a cold-mixed pie crust pastry or formulation from which cold-mixed pie crusts may be made. The further uses of the pie crusts that are manufactured in keeping with the present invention are outside the scope of the invention, as noted previously.

There has been described a cold-mixed pie crust pastry or formulation a methods of making the same, and there has been discussion of the frozen oil/fat system which is particularly in keeping with the present invention. It has been noted that quite unexpectedly a frozen oil/fat system as described above, derived from long-chain, naturally occurring oils having at least sixteen carbon atoms, functions very well and provides excellent flaky pie crusts which are essentially indistinguishable from pie crusts and pastries made with lard or hydrogenated vegetable oil shortening. Typically, the major constituents, and the mixing environment in which the pie crust formulations are made, are all cooled below +20° C.

Several typical formulations have been described for purposes of illustration only. Obviously, any specific pie crust formulation is within the skill of the baker who practices the present invention and in keeping with her or his experience and the nature of flour and oil employed, provided that a frozen oil/fat system in keeping with the present invention is employed.

Other modifications and alterations will be apparent to those skilled in the baking industry, and to those whose purpose is to provide baking ingredients to the baking industry, without departing from the spirit and scope of the accompanying claims.

Throughout this specification and the claims which follow, unless the context requires otherwise, the word ‘comprise’, and variations such as ‘comprises’ or ‘comprising’, will be understood to imply the inclusion of a stated integer or step or group of integers or steps but not to the exclusion of any other integer or step or group of integers or steps.

1. A cold-mixed pie crust comprising as its major constituents flour, water, and a frozen oil/fat system; wherein the frozen oil/fat system is a frozen long-chain, naturally occurring oil having at least sixteen carbon atoms.

2. The cold-mixed pie crust of claim 1, wherein the oil of the frozen oil/fat system is a naturally occurring saturated, partially saturated, or unsaturated oil chosen from the group consisting of canola oil, flaxseed oil, sunflower oil, corn oil, olive oil, soybean oil, peanut oil, cottonseed oil, safflower oil, palm oil, and mixtures and combinations thereof.

3. The cold-mixed pie crust of claim 1, wherein the oil has a freezing point of between +5° C. and −35° C., at which it has a consistency similar to that of pork lard at +4° C.

4. The cold-mixed pie crust of claim 1, wherein the major constituents are mixed together in a room or mixing environment having a temperature of +5° C. to 20° C.

5. The cold-mixed pie crust of claim 4, wherein up to 50% of the water constituent, when first mixed at least with the flour constituent, is shaved, flaked, or finely ground ice.

6. The cold-mixed pie crust of claim 1, wherein the ranges of the major constituents, in weight percentage, are as follows:
flour 45% to 59%
water 9% to 18%
frozen oil/fat system 22% to 35%

7. The cold-mixed pie crust of claim 6, further comprising minor constituents chosen from the group consisting of:
zero to 6.00% by weight of sweeteners;
zero to 2.00% by weight of salt;
zero to 0.50% by weight of leavening;
zero to 0.75% by weight of preservative.

8. The cold-mixed pie crust of claim 4, wherein the temperature of the flour constituent prior to mixing is in the range of 0° C. to +15° C.

9. The cold-mixed pie crust of claim 4, wherein the temperature of the pie crust mixture when first mixed is in the range of +5° C. to +10° C.

10. The cold-mixed pie crust of claim 1, wherein the oil is non-winterized.

11. A method of producing a cold-mixed pie crust mixture having reduced saturated fat and zero hydrogenated fat constituents, comprising the steps of:
(a) cooling a naturally occurring long-chain oil having at least sixteen carbon atoms to a freezing temperature in the range of +5° C. to −35° C., so as to obtain a frozen oil/fat system;
(b) cooling water to a temperature in the range of 0° C. to +15° C.;
(c) mixing flour, cooled water, and said frozen oil/fat system to form a cold-mixed pie crust mixture.

12. The method of claim 11, wherein the flour is cooled to a temperature of 0° C. to +15° C. prior to step (c).

13. The method of claim 11, wherein step (c) is carried out in a room or mixing environment having a temperature of +5° C. to +20° C.

14. The method of claim 11, wherein the oil is a naturally occurring saturated, partially saturated, or unsaturated oil chosen from the group consisting of canola oil, flaxseed oil, sunflower oil, corn oil, olive oil, soybean oil, peanut oil, cottonseed oil, safflower oil, palm oil, and mixtures and combinations thereof.

15. The method of claim 11, wherein the frozen oil/fat system from step (a) has a consistency similar to pork lard at +4° C.

16. The method of claim 11, wherein the cooled water of step (b) is substituted by cooled water together with up to 50% by weight of the water constituent of shaved, flaked, or finely ground ice.

17. The method of claim 11, wherein the ranges of flour, water, and frozen oil/fat system constituents of the pie crust mixture are as follows:
flour 46% to 59% by weight
water 9% to 18% by weight
frozen oil/fat system 22% to 35% by weight.

18. The method of claim 11, wherein the pie crust mixture comprises minor constituents chosen from the group consisting of:
zero to 6.00% by weight of sweeteners;
zero to 2.00% by weight of salt;
zero to 0.50% by weight of leavening;
zero to 0.75% by weight of preservative.

19. The method of claim 11, wherein the temperature of the mixture of step (c) is in the range of from +5° C. to +10° C.

20. The method of claim 11, wherein the oil is non-winterized.
